(19) United States
(12) Patent Application Publication
(10) Pub. No.: US 2005/0223513 A1
(43) Pub. Date: Oct. 13, 2005

(54) Calibration device

(75) Inventors: Peter Mau, Remscheid (DE); Markus Muller, Remscheid (DE)

Correspondence Address: DREISS, FUHLENDORF, STEIMLE & BECKER, POSTFACH 10 37 62, D-70032 STUTTGART, DE

(73) Assignee: Joh. Clouth GmbH & Co. KG

(21) Appl. No.: 11/099,494

(22) Filed: Apr. 6, 2005

(30) Foreign Application Priority Data
Apr. 8, 2004 (DE) 102004018421.6-27

(51) Int. Cl. B08B 1/00

(52) U.S. Cl. 15/256.51

(57) ABSTRACT

The invention concerns a calibration device for the pressure of a scraping device blade, which abuts the periphery of a roller or cylinder, in particular, of a paper machine, a printing machine, a calender or the like, comprising a holding blade, a sensor holder mounted thereto, and a pressure sensor, wherein the holding blade, the sensor holder and the pressure sensor are positioned such that the position of the pressure sensor on the periphery of the roller or cylinder corresponds to the position of abutment of the blade. The invention also concerns a method for adjusting a contact pressure of a blade which abuts the periphery of a roller or cylinder, in particular of a paper machine, a printing machine, a calender or the like.

This application claims Paris Convention priority of DE 10 2004 018 421.6 filed Apr. 8, 2004 the complete disclosure of which is hereby incorporated by reference.

### BACKGROUND OF THE INVENTION

The invention concerns a calibration device for the contact pressure of a blade of a scraping device which abuts on the periphery of a roller or a cylinder, in particular of a paper machine, a printing machine, a calender or the like. The invention also concerns a method for adjusting the contact pressure of a blade which abuts on the periphery of a roller or a cylinder, in particular, of a paper machine, a printing machine, a calender or the like.

Scraping devices clean the surface of a roller or cylinder. A scraping device of this type in a paper machine prevents the paper sheet guided over the respective roller of the paper machine from being wound onto the roller when the sheet is torn, rather to leave the roller at the predetermined location to be collected e.g. in a collection bin. The scraping device must perform this task with 100% reliability, since paper production would otherwise be considerably disturbed and the paper machine could even be damaged. For this reason, the blade in the scraping device must always uniformly abut the surface of the respective roller along the entire length of the scraper. The plane of the blade thereby extends at a slight angle with respect to the tangent to the contacting line on the roller surface.

To obtain a reliable scraping effect, the blade must be supported on the roller surface at a certain pressure. This pressure must not be too high since, with excessive pressure, the blade is quickly worn and has to be prematurely replaced. Moreover, the roller surface could also be damaged. For these reasons, the contact pressure must be as uniform as possible along the entire length of the roller to prevent uneven wear of the blade. Since there are no suitable measuring devices, the experience of the operator must be relied upon, as a result of which reproducible control values cannot be obtained.

It is therefore the underlying purpose of the invention to provide the person skilled in the art with a means and/or a method which permit reproducible setting of the contact pressure of the blades.

### SUMMARY OF THE INVENTION

This object is achieved with a calibration device of the above-mentioned type which comprises a holding blade, a sensor holder mounted thereto, and a pressure sensor, wherein the holding blade, the sensor holder and the pressure sensor are positioned such that the location of the pressure sensor on the periphery of the roller or the cylinder corresponds to the location of abutment of the blade. A calibration device of this type can be universally used, i.e. the calibration device can be used for blade holders of the most different construction.

The inventive calibration device simulates a blade clamped into a blade holder, and measures the pressure with which the sensor abuts the periphery of the roller or cylinder. The pressure sensor is thereby positioned exactly at that location where the scraping edge of the blade comes to rest. The blade holder is then adjusted to obtain the desired pressure values. The settings are stored to permit reproduction thereof after replacement of the calibration device with the actual blade. These stored values may e.g. be positions of adjusting screws, pressures of adjusting pistons or of inflatable hoses for adjusting the blade holder.

In a further development, the holding blade comprises a clamping end which is designed like the clamping end of the blade. This clamping end has, in particular, openings for receiving rivets to ensure secure mounting in the blade holder.

In one embodiment, the sensor holder has a slot on its side facing the holding blade, the slot having a height corresponding to the thickness of the holding blade. In accordance with the invention, the holding blade is inserted into this slot and is screwed or riveted to the sensor holder. Other mounting means such as e.g. gluing are also feasible.

The holding blade is designed to receive several sensor holders for measuring the contact pressure of the blade at several locations along its length. This mainly permits determination of whether the blade is oriented parallel to the axis of the roller or cylinder, which is the basic precondition for uniform contact pressure along the entire length and therefore for uniform wear. It is also possible to mount several holding blades in the blade holder.

The pressure sensor is preferably mounted to the side of the sensor holder facing away from the holding blade. The sensor holder is designed like a sampling finger and determines its associated pressure irrespective of the neighboring sensor holders.

In a preferred embodiment, the sensor holder is crimped or bent away from the plane of the holding blade and away from the roller to provide space for receiving the pressure sensor, which, in turn, is located at exactly that position where the scraping edge of the blade contacts the periphery of the roller.

The crimped or bent section thereby extends, at least partially, substantially tangentially with respect to the roller or cylinder. Since the roller or cylinder has a relatively large diameter, the crimped or bent section of the sensor holder extends substantially parallel to the surface of the roller and can easily receive the sensor. Slight position inaccuracies of the sensor on the sensor holder do not effect the measuring accuracy.

An elastic pad is disposed between the pressure sensor and the roller surface to protect the sensor from shocks. Shocks on the pressure sensor caused inevitably by dirt on the roller surface have no damaging effect on the sensor, since the sensor is protected by the elastic pad.

In accordance with the invention, the pad is made from a plastic material, in particular, from silicon. This material has turned out to be particularly long-lived and provides excellent distribution of the pressure forces to the pressure sensor.

Excellent measuring results were obtained with a tactile pressure sensor, i.e. a piezo element. These pressure sensors are extremely stable and provide reproducible values over a long period of time.

In one embodiment, the sensor holder is made from steel or a hard plastic material. The holding blade may also be made from steel, however, a holding blade which consists of plastic reinforced by carbon fibers is preferred due to its simplified handling. A holding blade having a length of several meters can be rolled up for transport and/or storage.

The above-mentioned object is also achieved by a method having the features of the principal method claim.

Further advantages, features and details can be extracted from the claims and the following detailed description of a particularly preferred embodiment with reference to the drawing. The features shown in the drawing and mentioned in the description and in the claims may be essential to the invention either individually or in arbitrary combination.

### BRIEF DESCRIPTION OF THE DRAWING

FIG. 1 shows a side view of the inventive calibration device;

FIG. 2 shows a side view of the sensor holder; and

FIG. 3 shows a top view onto a holding blade.

### DESCRIPTION OF THE PREFERRED EMBODIMENT

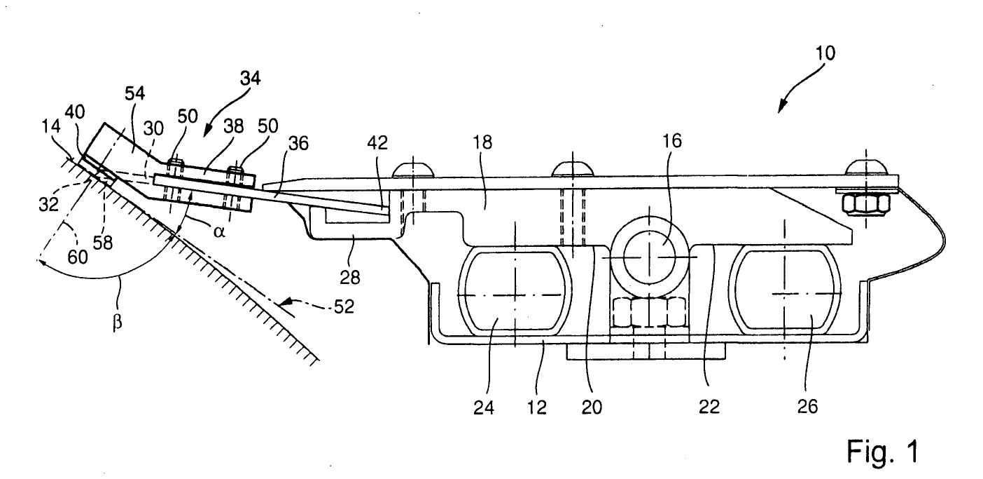

FIG. 1 shows a blade holder which is referred to in total by 10, whose rail 12 is mounted e.g. to the frame (not shown) of a roller. Only the surface 14 of the roller is shown. The rail 12 has a pivot bearing 16 to which a support 18 is pivotably mounted. This support 18 has two shoulders 20 and 22 below which inflatable hoses 24 and 26 are disposed which are again supported on the rail 12. The support 18 can be pivoted about the pivot bearing 16 through adjustment of different pressures in the hoses 24 and 26.

One end of the support 18 is designed as a receptacle 28 for a blade 30 whose scraping edge 32 seats on the roller surface 14. The receptacle 28 is conventional and is not described in detail. Instead of the blade 30 (broken lines), the receptacle 28 holds a calibration device, designated in total by 34, which comprises a holding blade 36, a sensor holder 38 and a pressure sensor 40. The holding blade 36 has a clamping end 42 which is designed like the clamping end of the blade 30. The holding blade 36 can therefore be mounted in the receptacle 28 of the blade holder 10 exactly like the blade 30.

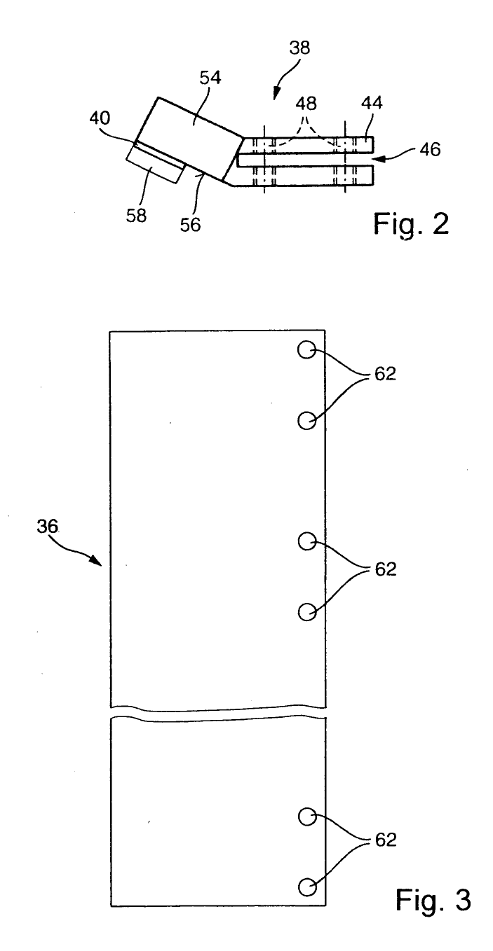

FIG. 2 shows the sensor holder 38 whose end 44 facing the holding blade 36 has a slot 46 whose height corresponds to the thickness of the holding blade 36. The end 44 is also provided with threaded bores 48 into which set screws 50 can be screwed (FIG. 1) to mount the sensor holder 38 to the holding blade 36. The slot 46 is oriented to subtend an angle α of 27° with respect to the tangent 52. A blade 30 and tangent 52 would also subtend this angle α.

The sensor holder 38 has a crimped section 54 which extends substantially parallel to the tangent 52 and surface 14 of the roller. The pressure sensor 40 is mounted to the side 56 facing the surface 14 and an elastic pad 58 is mounted on the pressure sensor 40. The elastic pad 58 is supported on the roller surface 14 and distributes the pressure acting on the pressure sensor 40 uniformly across its surface. The orthogonal 60 which extends through the pressure sensor 40 and the pad 58 subtends an angle β of 90° relative to the tangent 52.

FIG. 3 shows the holding blade 36 having openings 62 in which e.g. rivets can be mounted to reliably hold the holding blade 36 in the receptacle 28.

The contact pressure can be increased by increasing the pressure in the right-hand hose 26 and this can be detected by the pressure sensor 40. Different contact pressures can be associated with different pressures in the hoses 24 and 26 such that this pressure can be reproducibly generated on the scraping edge 32 after exchange of the calibration device 34 with a scraper blade 30.

1. A device for calibrating a contact pressure of a blade in a scraping device, the blade abutting a periphery of a roller or cylinder in a paper machine, a printing machine, a calender or another similar machine, the calibration device comprising:
a holding arm;
a sensor holder mounted to said holding arm; and
a pressure sensor cooperating with said sensor holder, wherein said holding arm, said sensor holder, and said pressure sensor are disposed, structured and dimensioned such that a position of said pressure sensor on the periphery of the roller or cylinder corresponds to a location of abutment of the blade.

2. The calibration device of claim 1, wherein said holding arm has a clamping end which is designed like a clamping end of the blade.

3. The calibration device of claim 1, wherein said sensor holder has a slot on its side facing said holding arm.

4. The calibration device of claim 3, wherein said slot has a height which corresponds to a thickness of said holding arm.

5. The calibration device of claim 1, wherein said holding arm is designed to receive several sensor holders.

6. The calibration device of claim 1, wherein said pressure sensor is structured and dimensioned for mounting to a side of said sensor holder facing away from said holding arm.

7. The calibration device of claim 1, wherein said sensor holder is crimped or bent away from a plane of said holding arm.

8. The calibration device of claim 7, wherein at least sections of a crimped or bent section of said sensor holder extends substantially tangentially to the roller or cylinder.

9. The calibration device of claim 1, wherein said pressure sensor is mounted to a side of said sensor holder facing the roller or cylinder.

10. The calibration device of claim 1, further comprising an elastic pad disposed between said pressure sensor and the roller periphery.

11. The calibration device of claim 10, wherein said pad consists essentially of plastic or silicon.

12. The calibration device of claim 1, wherein said pressure sensor is a tactile pressure sensor or a piezo element.

13. The calibration device of claim 1, wherein said sensor holder consists essentially of steel or plastic.

14. The calibration device of claim 1, wherein said holding arm consists essentially of steel or plastic which is reinforced by carbon fibers.

15. The calibration device of claim 1, wherein said sensor holder can be screwed to said holding arm at any position.

16. A method for adjusting a contact pressure of a blade in a scraping device, the blade abutting a periphery of a roller or cylinder in a paper machine, a printing machine, a calender or a similar machine, the method using a calibration device to simulate the blade when the blade is clamped into a blade holder, the method comprising the steps of:
a) measuring a pressure at which a pressure sensor abuts the periphery of the roller or cylinder;
b) adjusting the blade holder to obtain a desired pressure value;
c) storing settings to be reproduced after replacement of the calibration device by the actual blade; and
d) adjusting the blade holder using the stored settings.

17. The method of claim 16, wherein adjusting screws, pressures of adjustment cylinders, inflatable hoses, or weights are varied to adjust the blade holder.

18. The method of claim 16, wherein the pressure sensor is positioned at a location where a scraping edge of the blade comes to rest.
